(19) United States
(12) Patent Application Publication
(10) Pub. No.: US 2024/0292179 A1
(43) Pub. Date: Aug. 29, 2024

(54) LATE REVERBERATION DISTANCE ATTENUATION

(71) Applicant: Fraunhofer-Gesellschaft zur Förderung der angewandten Forschung e.V., München (DE)

(72) Inventors: Andreas SILZLE, Erlangen (DE); Jürgen HERRE, Erlangen (DE); Antti ERONEN, Tampere (FI)

(73) Assignee: Fraunhofer-Gesellschaft zur Förderung der angewandten Forschung e.V., München (DE)

(21) Appl. No.: 18/660,097

(22) Filed: May 9, 2024

Related U.S. Application Data
(63) Continuation of application No. PCT/EP2022/081084, filed on Nov. 8, 2022.

(30) Foreign Application Priority Data
Nov. 9, 2021 (EP) 21207191.4

(51) Int. Cl. H04S 7/00

(52) U.S. Cl. CPC H04S 7/305

(57) ABSTRACT

A renderer according to an embodiment is provided. The renderer is configured for rendering a virtual audio scene depending on one or more audio channels of each sound source of one or more sound sources emitting sound into the virtual audio scene, wherein, to process the one or more audio channels of said sound source. The renderer includes a late reverberation module configured for generating one or more late reverberation channels depending on the one or more audio channels of the sound source, wherein the one or more late reverberation channels represent a late-reverberation part of the sound emitted into the virtual audio scene by the sound source. Moreover, the renderer includes a sound scene generator for generating, using the one or more late-reverberation channels, one or more audio output channels for reproducing the virtual audio scene.

### CROSS-REFERENCES TO RELATED APPLICATIONS

This application is a continuation of co-pending International Application No. PCT/EP2022/081084, filed Nov. 8, 2022, which is incorporated herein by reference in its entirety, and additionally claims priority from European Application No. EP 21207191.4, filed Nov. 9, 2021, which is incorporated herein by reference in its entirety.

### BACKGROUND

A main aspect of simulated experiences like virtual reality (VR) or augmented reality (AR) is the ability to create physical spaces and environments in which a subject could perceive complex acoustical phenomena. This is especially the case in the so-called ‘six degrees of freedom’ (6DoF) rendering, in which a subject can move freely inside a room with certain physical properties and thus experience a variety of acoustic phenomena. The rendered sound generally consists of direct sound, an early reflections part (ER) and a late reverberation part (LR).

FIG. 3 illustrates a theoretical level of sound over distance dependency of point source in a closed room, and corresponds to FIG. 1.13 of [1]. In particular, FIG. 1 visualizes the level dependency of sound between a point source and a receiver (listener) over distance in a closed room. Near the sound source there are free field conditions, and the level drops by a factor of two or 6 dB per distance doubling. In a reverberant field, which is assumed to be totally diffuse, far away from the sound source, the level keeps constant. The border between these two areas is defined by the critical distance. The critical distance is calculated for an omnidirectional source and receiver by:

$${d}_{c} = \frac{1}{4} \sqrt{\frac{A}{π}} \approx 0.057 \sqrt{\frac{V}{R {T}_{60}}}$$

with A denoting the equivalent absorption area [m²], V is the room volume [m³], and RT₆₀ is the reverberation time [s] (see https://en.wikipedia.org/wiki/Critical_distance).

Modeling a sound source and a receiver in a room involves normally three different stages in a virtual environment auralization, namely, direct sound, early reflections and late reverberation processing.

FIG. 4 illustrates a standard implementation of a sound source in a room with the three stages, direct sound, early reflections and late reverberation processing.

As can be seen in FIG. 4, the first two stages have a distance dependent level adjustment: The larger the source-to-receiver distance will get, the more the level of both will drop. The level of the late reverberation stage is usually assumed to be constant within the room. At the above-mentioned critical distance the amount of direct sound level and reverberation level is equal. The reproduction stage finally renders the output to either binaural headphone or to loudspeaker reproduction.

### SUMMARY

An embodiment may have a renderer for rendering a virtual audio scene depending on one or more audio channels of each sound source of one or more sound sources emitting sound into the virtual audio scene, and for processing the one or more audio channels of said sound source, the renderer includes: a late reverberation module configured for generating one or more late reverberation channels depending on the one or more audio channels of the sound source, wherein the one or more late reverberation channels represent a late-reverberation part of the sound emitted into the virtual audio scene by the sound source, and a sound scene generator for generating, using the one or more late-reverberation channels, one or more audio output channels for reproducing the virtual audio scene, wherein the late reverberation module is configured to generate the one or more late reverberation channels depending on the one or more audio channels of the sound source depending on a distance between the sound source and a listener in the virtual audio scene.

Another embodiment may have an apparatus including, a decoder configured for decoding a bitstream to acquire the one or more audio channels of each sound source of one or more sound sources, and a renderer for rendering a virtual audio scene depending on one or more audio channels of each sound source of one or more sound sources emitting sound into the virtual audio scene, wherein, to process the one or more audio channels of said sound source, the renderer includes: a late reverberation module configured for generating one or more late reverberation channels depending on the one or more audio channels of the sound source, wherein the one or more late reverberation channels represent a late-reverberation part of the sound emitted into the virtual audio scene by the sound source, and a sound scene generator for generating, using the one or more late-reverberation channels, one or more audio output channels for reproducing the virtual audio scene, wherein the late reverberation module is configured to generate the one or more late reverberation channels depending on the one or more audio channels of the sound source depending on a distance between the sound source and a listener in the virtual audio scene.

Another embodiment may have a bitstream including, an encoding of one or more audio channels of each sound source of one or more sound sources emitting sound into a virtual audio scene, and one or more data fields comprising one or more information parameters which comprise an indication on a strength of a distance attenuation for late reverberation.

Another embodiment may have an encoder for generating a bitstream, wherein the encoder is configured to generate the bitstream such that the bitstream comprises an encoding of one or more audio channels of each sound source of one or more sound sources emitting sound into a virtual audio scene, and wherein the encoder is configured to generate the bitstream such that the bitstream further comprises one or more data fields comprising one or more information parameters which comprise an indication on a strength of a distance attenuation for late reverberation.

Another embodiment may have a method for rendering a virtual audio scene depending on one or more audio channels of each sound source of one or more sound sources emitting sound into the virtual audio scene, wherein, for processing the one or more audio channels of said sound source, the method includes: generating one or more late reverberation channels depending on the one or more audio channels of the sound source, wherein the one or more late reverberation channels represent a late reverberation part of the sound emitted into the virtual audio scene by the sound source, and generating, using the one or more late reverberation channels, one or more audio output channels for reproducing the virtual audio scene, wherein generating the one or more late reverberation channels depending on the one or more audio channels of the sound source is conducted depending on a distance between the object source to a listener in the virtual audio scene.

Another embodiment may have a method for generating a bitstream, including generating the bitstream such that the bitstream comprises an encoding of one or more audio channels of each sound source of one or more sound sources emitting sound into a virtual audio scene, and generating the bitstream such that the bitstream further comprises one or more data fields comprising one or more information parameters which comprise an indication on a strength of a distance attenuation for late reverberation.

Another embodiment may have a non-transitory digital storage medium having a computer program stored thereon to perform the method for rendering a virtual audio scene depending on one or more audio channels of each sound source of one or more sound sources emitting sound into the virtual audio scene, and for processing the one or more audio channels of said sound source, the method includes: generating one or more late reverberation channels depending on the one or more audio channels of the sound source, wherein the one or more late reverberation channels represent a late reverberation part of the sound emitted into the virtual audio scene by the sound source, and generating, using the one or more late reverberation channels, one or more audio output channels for reproducing the virtual audio scene, wherein generating the one or more late reverberation channels depending on the one or more audio channels of the sound source is conducted depending on a distance between the object source to a listener in the virtual audio scene, upon said computer program being run by a computer.

Another embodiment may have a non-transitory digital storage medium having a computer program stored thereon to perform the method for generating a bitstream, including generating the bitstream such that the bitstream includes an encoding of one or more audio channels of each sound source of one or more sound sources emitting sound into a virtual audio scene, and generating the bitstream such that the bitstream further comprises one or more data fields comprising one or more information parameters which comprise an indication on a strength of a distance attenuation for late reverberation, when said computer program is run by a computer.

A renderer according to an embodiment is provided. The renderer is configured for rendering a virtual audio scene depending on one or more audio channels of each sound source of one or more sound sources emitting sound into the virtual audio scene, wherein, to process the one or more audio channels of said sound source. The renderer includes a late reverberation module configured for generating one or more late reverberation channels depending on the one or more audio channels of the sound source, wherein the one or more late reverberation channels represent a late-reverberation part of the sound emitted into the virtual audio scene by the sound source. Moreover, the renderer comprises a sound scene generator for generating, using the one or more late-reverberation channels, one or more audio output channels for reproducing the virtual audio scene. The late reverberation module is configured to generate the one or more late reverberation channels depending on the one or more audio channels of the sound source depending on a distance between the sound source and a listener in the virtual audio scene.

Furthermore, a bitstream according to an embodiment is provided. The bitstream includes an encoding of one or more audio channels of each sound source of one or more sound sources emitting sound into a virtual audio scene. Moreover, the bitstream includes one or more data fields comprising one or more information parameters which comprise an indication on a strength of a distance attenuation for late reverberation.

Moreover, an encoder, configured for generating a bitstream, according to an embodiment is provided. The encoder is configured to generate the bitstream such that the bitstream includes an encoding of one or more audio channels of each sound source of one or more sound sources emitting sound into a virtual audio scene. Moreover, the encoder is configured to generate the bitstream such that the bitstream further includes one or more data fields including one or more information parameters which include an indication on a strength of a distance attenuation for late reverberation.

Furthermore, a method according to an embodiment is provided. The method is configured for rendering a virtual audio scene depending on one or more audio channels of each sound source of one or more sound sources emitting sound into the virtual audio scene, wherein, for processing the one or more audio channels of said sound source. The method includes:
Generating one or more late reverberation channels depending on the one or more audio channels of the sound source, wherein the one or more late reverberation channels represent a late reverberation part of the sound emitted into the virtual audio scene by the sound source; and
Generating, using the one or more late reverberation channels, one or more audio output channels for reproducing the virtual audio scene.

Generating the one or more late reverberation channels depending on the one or more audio channels of the sound source is conducted depending on a distance between the object source to a listener in the virtual audio scene.

Moreover, a method for generating a bitstream according to an embodiment is provided. The method includes:
Generating the bitstream such that the bitstream comprises an encoding of one or more audio channels of each sound source of one or more sound sources emitting sound into a virtual audio scene. And:
Generating the bitstream such that the bitstream further includes one or more data fields including one or more information parameters which include an indication on a strength of a distance attenuation for late reverberation.

Furthermore a computer program according to an embodiment for implementing one of the above-described methods when being executed on a computer or signal processor is provided.

### BRIEF DESCRIPTION OF THE DRAWINGS

Embodiments of the present disclosure will be detailed subsequently referring to the appended drawings, in which:

FIG. 1 illustrates a renderer for rendering a virtual audio scene according to an embodiment.

FIG. 2 illustrates an apparatus according to an embodiment comprising a decoder and the renderer of the embodiment of FIG. 1.

FIG. 3 illustrates a theoretical level of sound over distance dependency of point source in a closed room.

FIG. 4 illustrates a standard implementation of a sound source in a room with the three stages, namely direct sound, early reflections and late reverberation processing.

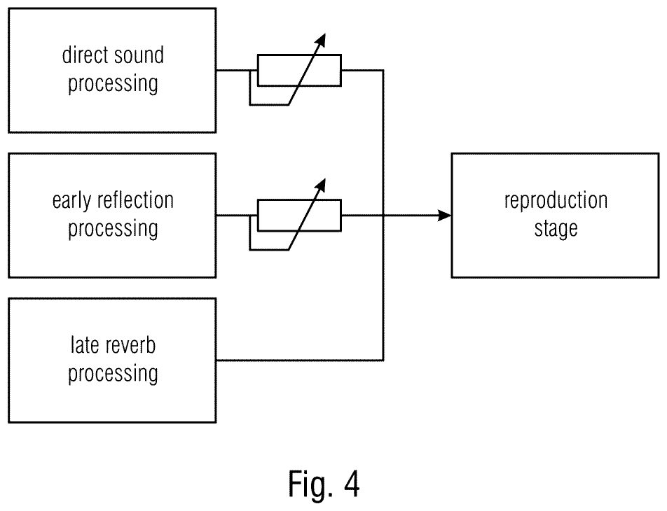

FIG. 5 illustrates the new behavior of the level dependency in the reverberant field according to an embodiment.

FIG. 6 illustrates a room simulation with the three stages, direct sound, early reflections and late reverberation processing, with distance dependent level adjustment according to an embodiment.

### DETAILED DESCRIPTION

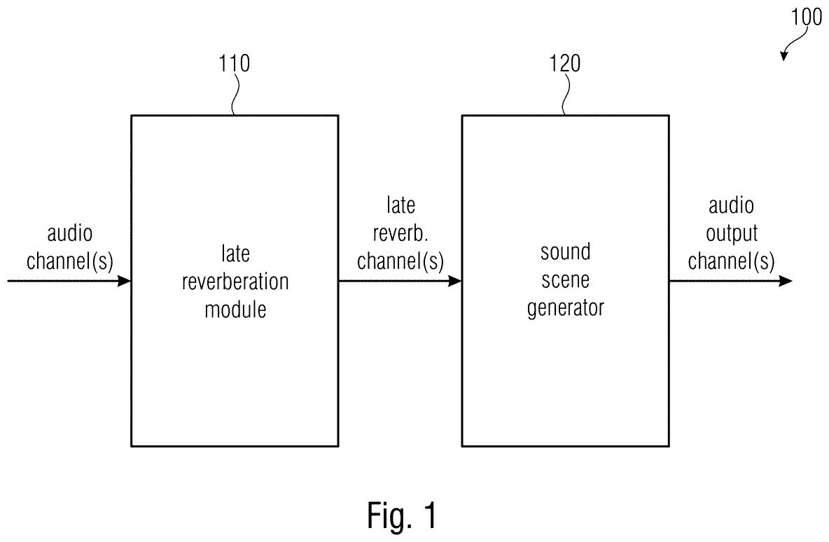

FIG. 1 illustrates a renderer 100 for rendering a virtual audio scene according to an embodiment.

A renderer 100 according to an embodiment is provided. The renderer 100 is configured for rendering a virtual audio scene depending on one or more audio channels of each sound source of one or more sound sources emitting sound into the virtual audio scene, wherein, to process the one or more audio channels of said sound source.

The renderer 100 comprises a late reverberation module 110 configured for generating one or more late reverberation channels depending on the one or more audio channels of the sound source, wherein the one or more late reverberation channels represent a late-reverberation part of the sound emitted into the virtual audio scene by the sound source.

Moreover, the renderer 100 comprises a sound scene generator 120 for generating, using the one or more late-reverberation channels, one or more audio output channels for reproducing the virtual audio scene.

The late reverberation module 110 is configured to generate the one or more late reverberation channels depending on the one or more audio channels of the sound source depending on a distance between the sound source and a listener in the virtual audio scene.

In an embodiment, the late reverberation module 110 may, e.g., be configured to generate the one or more late reverberation channels depending on the one or more audio channels of the sound source such that a sound pressure level and/or an amplitude and/or a magnitude and/or an energy of the one or more late reverberation channels may, e.g., be adapted depending on the distance between the sound source and the listener in the virtual audio scene.

According to an embodiment, the late reverberation module 110 may, e.g., be configured to render the sound pressure level and/or the amplitude and/or the magnitude and/or the energy of the one or more late reverberation channels such that a greater distance between the sound source and the listener in the virtual audio scene results in a stronger attenuation of the level and/or the amplitude and/or the energy of the one or more late reverberation channels compared to a smaller distance between the sound source and the listener in the virtual audio scene.

In an embodiment, the late reverberation module 110 may, e.g., be configured to render the sound pressure level and/or the amplitude and/or the magnitude and/or the energy of the one or more late reverberation channels depending on a first distance between the sound source and the listener, such that the sound pressure level of the one or more late reverberation channels may, e.g., be reduced by a value between 1 dB and 2 dB compared to a an attenuation of the one or more audio channels, if the distance between the sound source and the listener is half of the first distance.

According to an embodiment, the renderer 100 may, e.g., further comprise a direct sound module configured for generating one or more direct sound channels depending on the one or more audio channels of the sound source, such that a greater distance between the sound source and the listener in the virtual audio scene results in a stronger attenuation of the level and/or the amplitude and/or the energy of the one or more direct sound channels compared to a smaller distance between the sound source and the listener in the virtual audio scene,

wherein the sound scene generator 120 may, e.g., be configured to generate the one or more audio output channels for reproducing the virtual audio scene using the one or more direct sound channels.

In an embodiment, if the distance between the sound source and the listener in the virtual audio scene is the greater distance instead of the smaller distance, the late reverberation module 110 may, e.g., be configured to render the sound pressure level and/or the amplitude and/or the magnitude and/or the energy of the one or more late reverberation channels such that, the greater distance results in an attenuation of the sound pressure level and/or the amplitude and/or the magnitude and/or the energy of the one or more late reverberation channels which is relatively smaller compared to the attenuation of the level and/or the amplitude and/or the energy of the one or more direct sound channels conducted by the direct sound module in response to the greater distance.

According to an embodiment, compared to when a distance between the sound source and the listener in the virtual audio scene is half of a current distance, if the distance between the sound source and the listener in the virtual audio scene is the current distance, the late direct sound module may, e.g., be configured to render the sound pressure level and/or the amplitude and/or the magnitude and/or the energy of the one or more direct sound channels, such that the sound pressure level of the one or more direct sound channels is reduced by a value between 5 dB and 7 dB, and the late reverberation module 110 may, e.g., be configured to render the sound pressure level and/or the amplitude and/or the magnitude and/or the energy of the one or more late reverberation channels, such that the sound pressure level of the one or more late reverberation channels is reduced by a value between 1 dB and 2 dB.

In an embodiment, the renderer 100 may, e.g., be configured to receive one or more information parameters comprising an indication on a strength of a distance attenuation for late reverberation. The late reverberation module 110 may, e.g., be configured to adapt the sound pressure level and/or the amplitude and/or the magnitude and/or the energy of the one or more late reverberation channels depending on the distance between the sound source and the listener in the virtual audio scene and depending on the indication on the strength of the distance attenuation for late reverberation.

According to an embodiment, a bitstream may, e.g., comprise the one or more information parameters, and

wherein the renderer 100 may, e.g., be configured to receive the bitstream and may, e.g., be configured to obtain the one or more information parameters from the bitstream; or the renderer 100 may, e.g., be configured to receive the one or more information parameters from another unit that has received the bitstream and that has obtained the one or more information parameters from the bitstream.

In an embodiment, the one or more information parameters comprise a distance drop decibel factor and a reference distance. The late reverberation module 110 may, e.g., be configured to adapt the sound pressure level and/or the amplitude and/or the magnitude and/or the energy of the one or more late reverberation channels depending on the distance between the sound source and the listener in the virtual audio scene, depending on the distance drop decibel factor and depending on the reference distance.

According to an embodiment, the late reverberation module 110 may, e.g., be configured to adapt the sound pressure level and/or the amplitude and/or the magnitude and/or the energy of the one or more late reverberation channels depending on a gain dbGain that depends on:

$$distanceGainDbFactor * log 10 ( refDistance / distance ) ;$$

$$and$$

$$distanceGainDbFactor = distanceGainDropDb / log 10 ( 2. ) ;$$

distanceGainDropDb indicates the distance drop decibel factor; refDistance indicates the reference distance; and distance indicates the distance between the sound source and the listener in the virtual audio scene.

In an embodiment, the reference distance may, e.g., be a reference distance for an audio element according to MPEG-I 6DoF Audio Encoder Input Format (EIF), wherein the audio element may, e.g., be the sound source.

According to an embodiment, the late reverberation module 110 may, e.g., be configured to generate the one or more late reverberation channels using a feedback-delay-network reverberator.

In an embodiment, the renderer 100 may, e.g., further comprise an early reflection module configured for generating one or more early reflection channels depending on the one or more audio channels of the sound source. The sound scene generator 120 may, e.g., be configured to generate the one or more audio output channels for reproducing the virtual audio scene using the one or more early reflection channels.

In an embodiment, the renderer 100 may, e.g., be configured to determine the distance between the sound source and a listener in the virtual audio scene depending on a position of the sound source and depending on a position of the listener. The position of the sound source and the position of the listener are defined for three dimensions; and/or the position of the sound source and the position of the listener are defined for two dimensions; and/or the position of the sound source may, e.g., be defined for three dimensions, and the listener position and orientation may, e.g., be defined for six-degrees-of-freedom, such that the position of the listener may, e.g., be defined for three dimensions, and the orientation of a head of the listener may, e.g., be defined using three rotation angles.

According to an embodiment, the one or more audio channels of a sound source of the one or more sound sources are represented in an Ambisonics Domain, and wherein the sound scene generator 120 may, e.g., be configured to reproduce the virtual audio scene depending on a property of one of a plurality of Spherical Harmonics, being associated with one of the one or more audio channels of said sound source. Or, the one or more audio channels of said sound source are represented in a different domain being different from the Ambisonics Domain, wherein said one or more audio channels of said sound source are derived from one or more other channels of said sound source being represented in the Ambisonics domain, wherein each audio channel of the one or more audio channels may, e.g., be derived from one of the one or more other channels depending on a property of one of a plurality of Spherical Harmonics, being associated with said other channel.

In an embodiment, the renderer 100 may, e.g., comprise a binauralizer configured to generate two audio output channels for reproducing the virtual audio scene depending on the one or more late-reverberation channels.

According to an embodiment, a bitstream may, e.g., comprise the one or more audio channels of each sound source of the one or more sound sources. The renderer 100 may, e.g., be configured to receive the bitstream and may, e.g., be configured to obtain the one or more audio channels of each sound source of the one or more sound sources from the bitstream; or the renderer 100 may, e.g., be configured to receive the one or more audio channels of each sound source of the one or more sound sources from another unit that has received the bitstream and that has obtained the one or more audio channels of each sound source of the one or more sound sources from the bitstream.

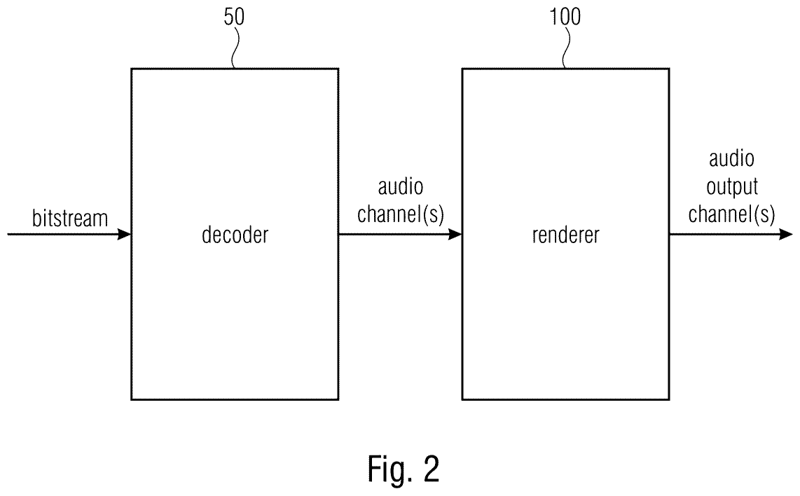

FIG. 2 illustrates an apparatus according to an embodiment comprising a decoder 50 and the renderer 100 of the embodiment of FIG. 1.

The decoder 50 is configured for decoding a bitstream to obtain the one or more audio channels of each sound source of one or more sound sources.

The renderer 100 is configured for rendering a virtual audio scene depending on the one or more audio channels of each sound source of the one or more sound sources.

According to an embodiment, the bitstream may, e.g., comprise the one or more information parameters. The decoder 50 may, e.g., be configured to obtain the one or more information parameters from the bitstream. Moreover, the renderer 100 may, e.g., be configured to receive the one or more information parameters from the decoder 50.

Furthermore, a bitstream according to an embodiment is provided. The bitstream comprises an encoding of one or more audio channels of each sound source of one or more sound sources emitting sound into a virtual audio scene. Moreover, the bitstream comprises one or more data fields comprising one or more information parameters which comprise an indication on a strength of a distance attenuation for late reverberation.

According to an embodiment, the one or more information parameters may, e.g., comprise a distance drop decibel factor and, optionally, a reference distance.

Moreover, an encoder, configured for generating a bitstream, according to an embodiment is provided. The encoder is configured to generate the bitstream such that the bitstream comprises an encoding of one or more audio channels of each sound source of one or more sound sources emitting sound into a virtual audio scene. Moreover, the encoder is configured to generate the bitstream such that the bitstream further comprises one or more data fields comprising one or more information parameters which comprise an indication on a strength of a distance attenuation for late reverberation.

According to an embodiment, the encoder may, e.g., be configured to generate the bitstream such that the one or more information parameters comprise a distance drop decibel factor and a reference distance.

In an embodiment, the encoder may, e.g., comprise an input interface configured for receiving the indication on the strength of the distance attenuation for late reverberation from a content creator.

According to an embodiment, the encoder may, e.g., comprise a determination module configured for determining the indication on the strength of the distance attenuation for late reverberation from a content creator by an automatic processing which depends on one or more properties of a virtual environment.

In the following, particular embodiments and considerations on which embodiments of the present disclosure are based are described.

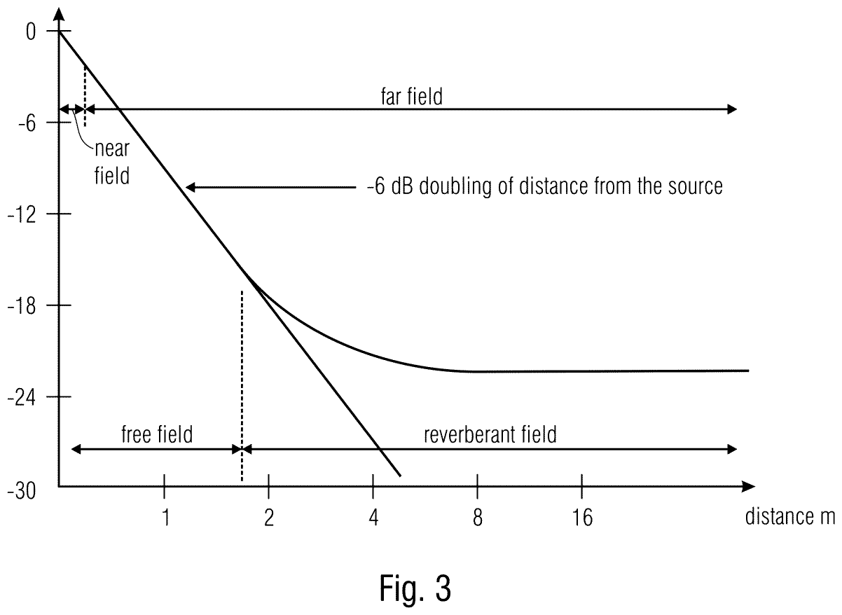

As mentioned above, in a state-of-the-art implementation the late reverb level is constant, i.e. it is independent of the source-to-listener distance and follows the theoretical behavior shown in FIG. 3. When rendering large reverberant spaces (e.g. a Cathedral with a sound source at the far end of the room) this leads to an unrealistic behavior because the overall level will never decrease when moving away from the source from outside the critical distance to arbitrary higher distances. Even after 1 km of additional distance, the level of the late reverb would not attenuate (if the simulated room is large enough).

From practical room acoustical measurements, however, it has been found that the level of the diffuse sound field is not completely constant beyond the critical distance in physical reality. Especially in large rooms, which are not completely diffuse, there is a smaller (than 6 dB per distance doubling) drop of the late reverberation. As a rule of thumb, the level drops beyond the critical distance with 1-2 dB per distance doubling, depending on the absorption characteristics of the wall material.

Embodiments of the disclosure provide a rendering with increased sense of realism by including this finding into interactive room simulation the practical experience.

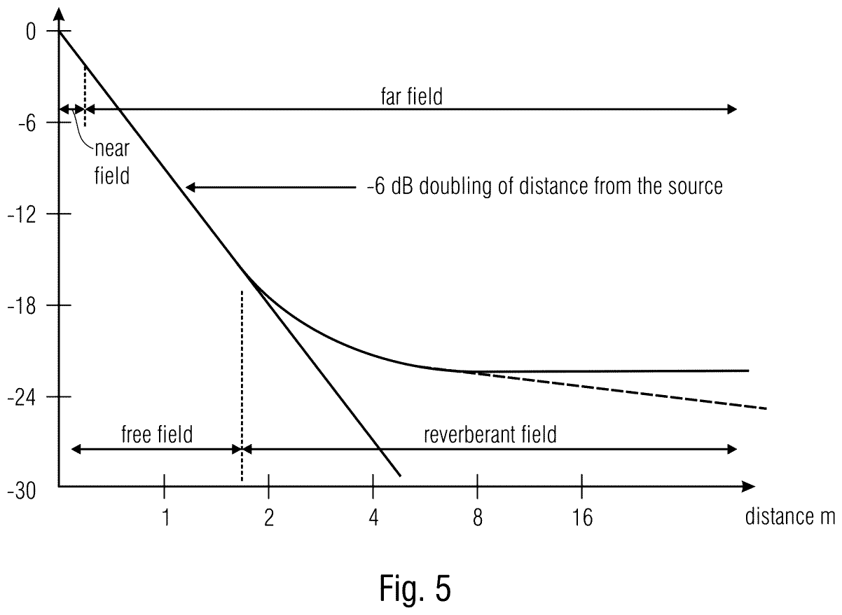

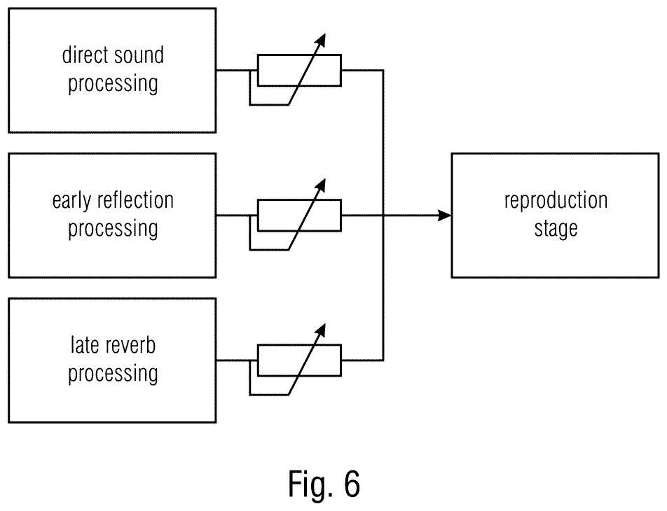

Embodiments described here achieve this by adding a source-listener distance dependent level change to the late reverb stage, see FIG. 5 and FIG. 6.

FIG. 5 illustrates the new behavior of the level dependency in the reverberant field according to an embodiment. The new behavior is depicted by the dashed (blue) line in FIG. 5 which shows a drop of the level dependency in the reverberant field of about 1-2 dB per distance doubling.

In the following, further particular embodiments are described.

FIG. 6 illustrates a room simulation with the three stages, direct sound, early reflections and late reverberation processing, with distance dependent level adjustment according to an embodiment.

The method for source-listener dependent level attenuation can be implemented before the Late Reverb Processing in FIG. 6, inside it, or after it as depicted in FIG. 6. In an advantageous implementation, the method is applied to the input of the signals going to Late Reverb Processing.

The inventive level adjustment method starts by obtaining the location (x, y, z) in Cartesian coordinates of the item to be rendered:

$$sourceLocation = item -> position . location ;$$

The method then obtains the absolute distance dist between the sourceLocation and listenerLocation (also in Cartesian coordinates):

$$dist = ( sourceLocation - listenerLocation ) . abs ( ) ;$$

The method then takes the maximum of dist and a minimumDistance value. This is done to prevent excessive level increase of the late reverb when being very close to a sound source. Currently minimumDistance is defined as 1 meter. In an embodiment, the late reverb minimumDistance can be signaled in the bitstream from a scene encoder to the scene decoder/renderer.

$$dist = max ( minimumDistance , dist ) ;$$

The distanceGain value to be applied to the reverb input signal is calculated by the method calculateDistanceGain, based on dist and the refDistance value of the rendered item. The refDistance is a reference distance in meters for the rendering item, defined by the content creator in an encoder input format file and signaled as a bitstream parameter. The reference distance is the distance at which the calculated attenuation for this input signal is 0 dB as defined in the MPEG-I Encoder Input Format [2].

$$distanceGain = calculateDistanceGain ( dist , item -> refDistance ) ;$$

$$itemGain = item -> gain ⋆ distanceGain ;$$

The itemGain then contains the gain to be applied to the reverb input signal for this rendering item, and combines any static gain defined in the bitstream by the content creator for this rendering item in item->gain and the calculated distanceGain.

The method performed in calculateDistanceGain is as follows:

$$dbGain = distanceGainDbFactor ⋆ log 10 ( refDistance / distance ) ;$$

$$distanceGain = pow ( 10. , dbGain / 20. ) ;$$

Here, distanceGainDbFactor is calculated as

$$distanceGainDbFactor = distanceGainDropDb / log 10 ( 2. ) ;$$

In an embodiment, distanceGaindDropDb is signaled in the bitstream and typically has values between 1 dB and 2 dB to implement a level decrease between of 1 dB to 2 dB per distance doubling.

The above equations are examples only: In other embodiments the linear gain can be calculated directly such that the desired attenuation (distanceGaindDropDb per distance doubling) is realized.

The input signal after the gain has been applied is fed into a digital reverberator. In an implementation, the digital reverberator is a feedback-delay-network (FDN) reverberator. Other suitable reverberator realizations can be used as well.

In the following, specific embodiments are described.

In one possible embodiment, distanceGaindDropDb can be determined by the content creator by experimenting with different values, listening to the output, and adjusting the value such that the output sounds perceptually plausible in all locations of the virtual scene given his experience and artistic intent.

In a different embodiment, distanceGaindDropDb can be determined by automatic encoder processing which performs the following steps:
Obtain a virtual environment comprising a geometry and one or more acoustic materials with at least acoustic absorption parameters
Select a source position in the virtual environment which is not too close to any of the boundaries of the virtual environment
Select a first receiver position at a position which is reference distance apart from the source position
Select at least one second receiver position having a distance greater than the reference distance from the source position
Perform acoustic modeling, using for example geometric acoustics modeling, wave based acoustic modeling, or a combination of these, to obtain a first impulse response at the first receiver position and a second impulse response at the second receiver position
From the first impulse response, obtain a first level value corresponding to a time interval of diffuse late reverberation
From the second impulse response, obtain a second level value corresponding to a time interval of diffuse late reverberation
Perform line fitting to the first level value and the second level value, in decibels, to obtain the slope of a line
Signal the slope of the line as distanceGainDropDb to a rendering apparatus in a bitstream

The above method is applicable to rendering of Virtual Reality (VR) scenes where there is a virtual scene provided to an encoder apparatus, which can determine and signal suitable parameters (such as the distance-dependent level attenuation) to a rendering apparatus.

In some embodiments, the rendering is done in augmented reality (AR) scenarios, in which case data about the reproduction room is not available for the encoder apparatus but information of the user listening space and its acoustics (such as dimensions, materials, and reverberation times) are provided only during rendering time e.g. as a listening-space-description file.

For large indoor spaces, implementing distance-dependent level attenuation to late reverb processing is useful and can increase the realism of audio reproduction.

In one embodiment of the disclosure, a similar method of acoustic simulation as presented above is applied by a rendering apparatus when it receives the listening-space-description file parameters. The procedure produces the distanceGainDropDb parameter which can be used for rendering reverberation and producing source-listener dependent distance gain attenuation when the listener is within the space defined by the listening-space-description file.

However, since the AR processing is executed at renderer start-up which must not take too long, it is desirable for the procedure executed at the renderer to be computationally more straightforward than what is executed at the encoder.

In an embodiment of the disclosure, instead of performing acoustic simulation using the listening-space-description file, the procedure calculates the volume of the space described in the listener space description file and/or the average of the material absorption coefficients of the listener space description file and performs a mapping from the volume of the listening space and its average absorption coefficients to a suitable value for the distance-dependent level attenuation. For example, small spaces with low average absorption may receive small value for distanceGainDropDb meaning that there will be almost no source-listener dependent distance attenuation for late reverb whereas larger spaces with more absorption will receive larger values for distanceGainDropDb which means that there will be a certain degree of distance-dependent level attenuation for such spaces.

In the following, aspects of some of the embodiments are described.

At first, rendering aspects according to some particular embodiments are described.

According to an embodiment, a renderer is provided that is equipped to render a virtual audio scene including one or more sound sources and that includes a stage for rendering of late reverb, and the late reverb rendering depends on one or more reverb control parameters including a reverb time (e.g. RT60) characterized in that the late reverb level is rendered depending on the distance between the source and the listener, and depending on a measure of the strength of the distance attenuation.

In an embodiment, this measure of the strength of the late reverb distance attenuation indicates the relative attenuation increase, expressed in Decibels, for each doubling of the distance.

In a further embodiment, a value of 1-2 dB per distance doubling is applied

In a further embodiment, the measure of the strength of the late reverb distance attenuation is read from a bitstream.

Now, bitstream aspects according to some particular embodiments are described.

A bitstream for rendering of acoustic scenes by a renderer characterized in that for at least one description of late reverberation in certain parts of the scene, a bitstream field is included that indicates the strength of a distance attenuation that is applied for the rendering of late reverb in this part of the scene.

In an embodiment, this field that indicates the strength of the reverb distance attenuation represents the relative attenuation increase, expressed in Decibels, for each doubling of the distance.

Application fields of particular embodiments may, for example, be the field of real-time auditory virtual environment or the field of real-time virtual and augmented reality.

It is to be mentioned here that all alternatives or aspects as discussed before and all aspects as defined by independent claims in the following claims can be used individually, i.e., without any other alternative or object than the contemplated alternative, object or independent claim. However, in other embodiments, two or more of the alternatives or the aspects or the independent claims can be combined with each other and, in other embodiments, all aspects, or alternatives and all independent claims can be combined to each other.

An inventively encoded or processed signal can be stored on a digital storage medium or a non-transitory storage medium or can be transmitted on a transmission medium such as a wireless transmission medium or a wired transmission medium such as the Internet.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the disclosure can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the disclosure comprise a data carrier having electronically readable control signals, which are capable of cooperating with a programmable computer system, such that one of the methods described herein is performed.

Generally, embodiments of the present disclosure can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier or a non-transitory storage medium.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The above described embodiments are merely illustrative for the principles of the present disclosure. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

1. A renderer for rendering a virtual audio scene depending on one or more audio channels of each sound source of one or more sound sources emitting sound into the virtual audio scene, and for processing the one or more audio channels of said sound source, the renderer comprises:
a late reverberation module configured for generating one or more late reverberation channels depending on the one or more audio channels of the sound source, wherein the one or more late reverberation channels represent a late-reverberation part of the sound emitted into the virtual audio scene by the sound source; and
a sound scene generator for generating, using the one or more late-reverberation channels, one or more audio output channels for reproducing the virtual audio scene,
wherein the late reverberation module is configured to generate the one or more late reverberation channels depending on the one or more audio channels of the sound source depending on a distance between the sound source and a listener in the virtual audio scene.

2. A renderer according to claim 1,
wherein the late reverberation module is configured to generate the one or more late reverberation channels depending on the one or more audio channels of the sound source such that a sound pressure level or an amplitude or a magnitude or an energy of the one or more late reverberation channels is adapted depending on the distance between the sound source and the listener in the virtual audio scene.

3. A renderer according to claim 2,
wherein the late reverberation module is configured to render the sound pressure level or the amplitude and/or the magnitude and/or the energy of the one or more late reverberation channels such that a greater distance between the sound source and the listener in the virtual audio scene results in a stronger attenuation of the level or the amplitude or the energy of the one or more late reverberation channels compared to a smaller distance between the sound source and the listener in the virtual audio scene.

4. A renderer according to claim 2,
wherein the late reverberation module is configured to render the sound pressure level or the amplitude or the magnitude and/or the energy of the one or more late reverberation channels depending on a first distance between the sound source and the listener, such that the sound pressure level of the one or more late reverberation channels is reduced by a value between 1 dB and 2 dB compared to a an attenuation of the one or more audio channels, upon determining that the distance between the sound source and the listener is half of the first distance.

5. A renderer according to claim 1,
wherein the renderer further comprises a direct sound module configured for generating one or more direct sound channels depending on the one or more audio channels of the sound source, such that a greater distance between the sound source and the listener in the virtual audio scene results in a stronger attenuation of the level or the amplitude or the energy of the one or more direct sound channels compared to a smaller distance between the sound source and the listener in the virtual audio scene, and
wherein the sound scene generator is configured to generate the one or more audio output channels for reproducing the virtual audio scene using the one or more direct sound channels.

6. A renderer according to claim 5,
wherein, upon determining that the distance between the sound source and the listener in the virtual audio scene is the greater distance instead of the smaller distance, the late reverberation module is configured to render the sound pressure level or the amplitude and/or the magnitude or the energy of the one or more late reverberation channels such that, the greater distance results in an attenuation of the sound pressure level or the amplitude or the magnitude or the energy of the one or more late reverberation channels which is relatively smaller compared to the attenuation of the level or the amplitude or the energy of the one or more direct sound channels conducted by the direct sound module in response to the greater distance.

7. A renderer according to claim 6,
wherein, compared to when a distance between the sound source and the listener in the virtual audio scene is half of a current distance, upon determining that the distance between the sound source and the listener in the virtual audio scene is the current distance,
the late direct sound module is configured to render the sound pressure level or the amplitude or the magnitude or the energy of the one or more direct sound channels, such that the sound pressure level of the one or more direct sound channels is reduced by a value between 5 dB and 7 dB, and
the late reverberation module is configured to render the sound pressure level or the amplitude or the magnitude and/or the energy of the one or more late reverberation channels, such that the sound pressure level of the one or more late reverberation channels is reduced by a value between 1 dB and 2 dB.

8. A renderer according to claim 2,
wherein the renderer is configured to receive one or more information parameters comprising an indication on a strength of a distance attenuation for late reverberation, and
wherein the late reverberation module is configured to adapt the sound pressure level or the amplitude or the magnitude or the energy of the one or more late reverberation channels depending on the distance between the sound source and the listener in the virtual audio scene and depending on the indication on the strength of the distance attenuation for late reverberation.

9. A renderer according to claim 8,
wherein a bitstream comprises the one or more information parameters, and wherein the renderer is configured to receive the bitstream and is configured to acquire the one or more information parameters from the bitstream, or the renderer is configured to receive the one or more information parameters from another unit that has received the bitstream and that has acquired the one or more information parameters from the bitstream.

10. A renderer according to claim 8,
wherein the one or more information parameters comprise a distance drop decibel factor and a reference distance, and
wherein the late reverberation module is configured to adapt the sound pressure level or the amplitude or the magnitude or the energy of the one or more late reverberation channels depending on the distance between the sound source and the listener in the virtual audio scene, depending on the distance drop decibel factor and depending on the reference distance.

11. A renderer according to claim 10,
wherein the late reverberation module is configured to adapt the sound pressure level or the amplitude or the magnitude or the energy of the one or more late reverberation channels depending on a gain dbGain that depends on:
distanceGainDbFactor*log 10(refDistance/distance); and
distanceGainDbFactor=distanceGainDropDb/log 10(2.0);
wherein distanceGainDropDb indicates the distance drop decibel factor,
wherein refDistance indicates the reference distance; and
wherein distance indicates the distance between the sound source and the listener in the virtual audio scene.

12. A renderer according to claim 10,
wherein the reference distance is a reference distance for an audio element according to MPEG-I 6DoF Audio Encoder Input Format (EIF), wherein the audio element is the sound source.

13. A renderer according to claim 1,
wherein the late reverberation module is configured to generate the one or more late reverberation channels using a feedback-delay-network reverberator.

14. A renderer according to claim 1,
wherein the renderer further comprises an early reflection module configured for generating one or more early reflection channels depending on the one or more audio channels of the sound source,
wherein the sound scene generator is configured to generate the one or more audio output channels for reproducing the virtual audio scene using the one or more early reflection channels.

15. A renderer according to claim 1,
wherein the renderer is configured to determine the distance between the sound source and a listener in the virtual audio scene depending on a position of the sound source and depending on a position of the listener,
wherein the position of the sound source and the position of the listener are defined for three dimensions,
wherein the position of the sound source and the position of the listener are defined for two dimensions, or
wherein the position of the sound source is defined for three dimensions, and the listener position and orientation is defined for six-degrees-of-freedom, such that the position of the listener is defined for three dimensions, and the orientation of a head of the listener is defined using three rotation angles.

16. A renderer according to claim 1,
wherein the one or more audio channels of a sound source of the one or more sound sources are represented in an Ambisonics Domain, and wherein the sound scene generator is configured to reproduce the virtual audio scene depending on a property of one of a plurality of Spherical Harmonics, being associated with one of the one or more audio channels of said sound source, or
wherein the one or more audio channels of said sound source are represented in a different domain being different from the Ambisonics Domain, wherein said one or more audio channels of said sound source are derived from one or more other channels of said sound source being represented in the Ambisonics domain, wherein each audio channel of the one or more audio channels is derived from one of the one or more other channels depending on a property of one of a plurality of Spherical Harmonics, being associated with said other channel.

17. A renderer according to claim 1,
wherein the renderer comprises a binauralizer configured to generate two audio output channels for reproducing the virtual audio scene depending on the one or more late-reverberation channels.

18. A renderer according to claim 1,
wherein a bitstream comprises the one or more audio channels of each sound source of the one or more sound sources,
wherein the renderer is configured to receive the bitstream and is configured to acquire the one or more audio channels of each sound source of the one or more sound sources from the bitstream, or the renderer is configured to receive the one or more audio channels of each sound source of the one or more sound sources from another unit that has received the bitstream and that has acquired the one or more audio channels of each sound source of the one or more sound sources from the bitstream.

19. An apparatus comprising,
a decoder configured for decoding a bitstream to acquire the one or more audio channels of each sound source of one or more sound sources; and
a renderer for rendering a virtual audio scene depending on one or more audio channels of each sound source of one or more sound sources emitting sound into the virtual audio scene, wherein, to process the one or more audio channels of said sound source, the renderer comprises:
a late reverberation module configured for generating one or more late reverberation channels depending on the one or more audio channels of the sound source, wherein the one or more late reverberation channels represent a late-reverberation part of the sound emitted into the virtual audio scene by the sound source; and
a sound scene generator for generating, using the one or more late-reverberation channels, one or more audio output channels for reproducing the virtual audio scene;
wherein the late reverberation module is configured to generate the one or more late reverberation channels depending on the one or more audio channels of the sound source depending on a distance between the sound source and a listener in the virtual audio scene.

20. An apparatus according to claim 19,
wherein the renderer is configured to receive the bitstream and is configured to acquire the one or more information parameters from the bitstream, or the renderer is configured to receive the one or more information parameters from another unit that has received the bitstream and that has acquired the one or more information parameters from the bitstream,
wherein the bitstream comprises the one or more information parameters,
wherein the decoder is configured to acquire the one or more information parameters from the bitstream, and
wherein the renderer is configured to receive the one or more information parameters from the decoder.

21. A bitstream comprising:
an encoding of one or more audio channels of each sound source of one or more sound sources emitting sound into a virtual audio scene; and
one or more data fields comprising one or more information parameters which comprise an indication on a strength of a distance attenuation for late reverberation.

22. A bitstream according to claim 21,
wherein the one or more information parameters comprise a distance drop decibel factor and, a reference distance.

23. An encoder for generating a bitstream,
wherein the encoder is configured to generate the bitstream such that the bitstream comprises an encoding of one or more audio channels of each sound source of one or more sound sources emitting sound into a virtual audio scene, and
wherein the encoder is configured to generate the bitstream such that the bitstream further comprises one or more data fields comprising one or more information parameters which comprise an indication on a strength of a distance attenuation for late reverberation.

24. An encoder according to claim 23,
wherein the encoder is configured to generate the bitstream such that the one or more information parameters comprise a distance drop decibel factor and a reference distance.

25. An encoder according to claim 23,
wherein the encoder comprises an input interface configured for receiving the indication on the strength of the distance attenuation for late reverberation from a content creator.

26. An encoder according to claim 23,
wherein the encoder comprises a determination module configured for determining the indication on the strength of the distance attenuation for late reverberation from a content creator by an automatic processing which depends on one or more properties of a virtual environment.

27. A method for rendering a virtual audio scene depending on one or more audio channels of each sound source of one or more sound sources emitting sound into the virtual audio scene, and for processing the one or more audio channels of said sound source, the method comprises:
generating one or more late reverberation channels depending on the one or more audio channels of the sound source, wherein the one or more late reverberation channels represent a late reverberation part of the sound emitted into the virtual audio scene by the sound source; and
generating, using the one or more late reverberation channels, one or more audio output channels for reproducing the virtual audio scene,
wherein generating the one or more late reverberation channels depending on the one or more audio channels of the sound source is conducted depending on a distance between the object source to a listener in the virtual audio scene.

28. A method for generating a bitstream, comprising
generating the bitstream such that the bitstream comprises an encoding of one or more audio channels of each sound source of one or more sound sources emitting sound into a virtual audio scene; and
generating the bitstream such that the bitstream further comprises one or more data fields comprising one or more information parameters which comprise an indication on a strength of a distance attenuation for late reverberation.

29. A non-transitory digital storage medium having a computer program stored thereon to perform the method for rendering a virtual audio scene depending on one or more audio channels of each sound source of one or more sound sources emitting sound into the virtual audio scene, and for processing the one or more audio channels of said sound source, the method comprises:
generating one or more late reverberation channels depending on the one or more audio channels of the sound source, wherein the one or more late reverberation channels represent a late reverberation part of the sound emitted into the virtual audio scene by the sound source; and
generating, using the one or more late reverberation channels, one or more audio output channels for reproducing the virtual audio scene,
wherein generating the one or more late reverberation channels depending on the one or more audio channels of the sound source is conducted depending on a distance between the object source to a listener in the virtual audio scene, upon said computer program being run by a computer.

30. A non-transitory digital storage medium having a computer program stored thereon to perform the method for generating a bitstream, comprising:
generating the bitstream such that the bitstream comprises an encoding of one or more audio channels of each sound source of one or more sound sources emitting sound into a virtual audio scene; and
generating the bitstream such that the bitstream further comprises one or more data fields comprising one or more information parameters which comprise an indication on a strength of a distance attenuation for late reverberation;
upon said computer program being run by a computer.
